(19) United States
(12) Patent Application Publication
(10) Pub. No.: US 2004/0128524 A1
(43) Pub. Date: Jul. 1, 2004

(54) Delivery system for delivery items, delivery agency server apparatus, cryptogram reader, delivery method for delivery items, program, and recording medium

(75) Inventor: Tadashi Ezaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/657,202

(22) Filed: Sep. 9, 2003

(30) Foreign Application Priority Data
Sep. 18, 2002 (JP) 2002-272197

(51) Int. Cl. H04L 9/32; G06F 11/30; G06F 12/14

(52) U.S. Cl. 713/189

(57) ABSTRACT

It is requested to deliver items by concealing private information about a sender and a recipient without installing a database for storing information which requires strict management. A recipient's terminal apparatus obtains a delivery agency's public key from a delivery agent server apparatus. An encryption program of the delivery agency is downloaded in advance and uses the public key to encrypt recipient information containing at least recipient's private information needed for delivery of items. The recipient's encryption information is transmitted to a sender's terminal apparatus. The sender's terminal apparatus outputs the recipient's encryption information to be attached to an item entrusted to the delivery agency. A cryptogram reader of the delivery agency decrypts the output recipient's encryption information using the delivery agency's secret key. The delivery agency obtains the information about delivery destination of the recipient.

### BACKGROUND OF THE INVENTION

1. Field of the Invention

The present invention relates to a delivery system for delivery items, a delivery agency server apparatus, a cryptogram reader, a delivery method for delivery items, a program, and a recording medium. More specifically, the present invention relates to a delivery system allowing delivery items to be delivered without disclosing private information about a recipient or a sender to the other party.

2. Description of Related Art

In recent years, there is a rapidly increasing trend of using methods of trading commodities by means of electronic mail, bulletin board systems, and online auctions on the Internet. In the course of such method of trading commodities using the Internet, a sender and a recipient often do not want to notify his or her own private information to each other. In the case of Internet shopping, a recipient may not want to disclose his or her private information to the shop.

To solve this problem, there is proposed a method of carrying out the Internet shopping without disclosing the private information (e.g., refer to patent document 1). According to this method, a delivery service company installs a server apparatus having a database that stores ID numbers and private information associated with each other. The company delivers a delivery item by notifying only its ID number to the corresponding shop.

[Patent Document 1]

JP-A No. 7904/2002

However, the method according to patent document 1 above must manage the server apparatus so as to fully secure the privacy of the information stored in the database of the server apparatus. Incorrectly managing the server apparatus may leak the private information. If the entire database is stolen, there may arise a possibility of leaking all the private information out of the database. Using an incorrect ID number may cause a problem of delivering the item to a completely different destination. Furthermore, a delivery agency must inquire into the server apparatus, disabling the offline use of the system.

### SUMMARY OF THE INVENTION

It is therefore an object of the present invention to provide a new, improved item delivery system capable of delivering items by securing secrecy of the sender's and recipient's private information without installing the above-mentioned database for storing the information that requires the strict management.

According to a first aspect of the present invention in order to solve the above-mentioned problems, there is provided an item delivery system in which a public switched telephone network is used to make connection between a sender's terminal apparatus of a sender entrusting delivery of a delivery item to a delivery agency and a recipient's terminal apparatus of a recipient receiving the delivery item, wherein the recipient's terminal apparatus obtains a public key of the delivery agency via a specified medium, uses the public key to encrypt recipient information containing at least recipient's private information needed for delivery of items and to generate recipient's encryption information, and transmits the recipient's encryption information to the sender's terminal apparatus; wherein the sender's terminal apparatus outputs the transmitted recipient's encryption information in order to be attached to a delivery item entrusted to the delivery agency; and wherein the delivery agency's cryptogram reader decrypts the output recipient's encryption information using the delivery agency's secret key so that the delivery agency obtains the recipient information.

Since the invention mentioned above uses the public key to encrypt the recipient's private information, an item is delivered without disclosing the private information to the sender. In this case, it is unnecessary to use a database for storing private information about the recipient or the sender, maximally preventing a leak of the private information. If an encryption key is stolen, it is possible to limit the leak of secrets to that of the private information about the delivery item that uses the stolen encryption key. It is possible to not only save labors for the server management, but also reduce costs for providing a delivery system that can conceal the private information. Moreover, the delivery agency need not inquire a server apparatus, making it possible to convert the destination offline.

The recipient's terminal apparatus may be configured to attach information about the delivery agency's public key to the recipient's encryption information and transmits it to the sender's terminal apparatus. In this configuration, the delivery agency can reference the information and use a plurality of pairs of public keys and secret keys.

The sender's terminal apparatus may be configured to obtain a public key of the delivery agency via a specified medium, uses the public key to encrypt sender information about a sender to generate sender's encryption information, and outputs the sender's encryption information to be attached to a delivery item entrusted to the delivery agency; wherein the delivery agency's cryptogram reader decrypts the output sender's encryption information using the delivery agency's secret key so that the delivery agency obtains the sender information. In this configuration, the delivery agency can identify the sender's private information without permitting the recipient to know the sender's private information.

The recipient's encryption information may be configured to comprise at least coded information. In this configuration, the recipient's encryption information (or the sender's encryption information as needed) comprises coded information such as a bar or a two-dimensional bar code. The cryptogram reader can be used to easily and automatically recognize the recipient information (or the sender information as needed).

An output of the recipient's encryption information may be configured to contain at least a name identifying the recipient. In this configuration, it is possible to identify the recipient (or the sender as needed) without disclosing the recipient's real name (or the sender's real name as needed).

According to a second aspect of the present invention in order to solve the above-mentioned problems, there is provided a delivery agency server apparatus of a delivery agency which delivers a delivery item entrusted by a sender to a recipient, wherein a public switched telephone network is used to make connection between a sender's terminal apparatus of the sender entrusting delivery of the delivery item to the delivery agency and a recipient's terminal apparatus of the recipient receiving the delivery item, and the delivery agent server apparatus includes: a public key management means for managing a public key to execute an encryption program which encrypts recipient information containing at least recipient's private information needed for delivery of delivery items; a public key transmission means for transmitting the public key to the recipient's terminal apparatus in response to a request from the recipient's terminal apparatus; a secret key management means for managing a secret key to decrypt recipient's encryption information encrypted and generated by the encryption program using the public key from recipient information containing at least recipient's private information needed for delivery of delivery items; and a secret key provision means for providing the secret key to a cryptogram reader which decrypts the recipient's encryption information.

Since the invention mentioned above uses the public key to encrypt the recipient's private information, there is provided the delivery agent server apparatus for delivering an item without disclosing the private information to the sender. In this case, the delivery agent server apparatus does not need a database for storing private information about the recipient or the sender, maximally preventing a leak of the private information. If an encryption key is stolen, it is possible to limit the leak of secrets to that of the private information about the delivery item that uses the stolen encryption key. It is possible to not only save labors for the server management, but also reduce costs for providing a delivery system that can conceal the private information. Moreover, the delivery agency need not inquire a server apparatus, making it possible to convert the destination offline.

Further more, the public key transmission means can transmit the public key to the sender's terminal apparatus in response to a request from the sender's terminal apparatus. The encryption program can use the public key to encrypt sender information about the sender and generate sender's encryption information. The secret key can decrypt the sender's encryption information. In this configuration, the delivery agency can identify the sender's private information without permitting the recipient to know the sender's private information.

An output of the recipient's encryption information may be configured to contain at least a name identifying the recipient. In this configuration, it is possible to identify the recipient (or the sender as needed) without disclosing the recipient's real name (or the sender's real name as needed).

According to a third aspect of the present invention in order to solve the above-mentioned problems, there is provided a cryptogram reader connectable to a delivery agency server apparatus of a delivery agency which delivers a delivery item entrusted by a sender to a recipient, wherein a public switched telephone network is used to make connection between a sender's terminal apparatus of the sender entrusting delivery of the delivery item to the delivery agency and a recipient's terminal apparatus of the recipient receiving the delivery item, and the cryptogram reader includes: a means for obtaining a secret key from a server apparatus in order to decrypt recipient's encryption information encrypted and generated from at least recipient information needed for delivery of delivery items by means of an encryption program using a public key of the delivery agency; a means for reading the recipient's encryption information and decrypting it using the secret key; and a means for outputting the decrypted recipient's encryption information as human-readable recipient information.

According to the above-mentioned invention, the delivery agency can easily decrypt the recipient's encoded private information without permitting it to be known to the sender. Since there is no need to inquire a server apparatus, it is possible to convert the destination offline.

The cryptogram reader can decrypt sender's encryption information as sender's private information encrypted by the encryption program using the public key. The cryptogram reader can output the encrypted sender's encryption information as human-readable sender information. In this configuration, the delivery agency can easily decrypt the sender's encoded private information without permitting it to be known to the recipient.

According to a fourth aspect of the present invention in order to solve the above-mentioned problems, there is provided an item delivery method in which a public switched telephone network is used to make connection between a sender's terminal apparatus of a sender entrusting delivery of a delivery item to a delivery agency and a recipient's terminal apparatus of a recipient receiving the delivery item, wherein the recipient's terminal apparatus obtains a public key of the delivery agency via a specified medium, uses the public key to encrypt recipient information containing at least recipient s private information needed for delivery of items and to generate recipient's encryption information, and transmits the recipient's encryption information to the sender's terminal apparatus; wherein the sender's terminal apparatus outputs the transmitted recipient's encryption information in order to be attached to a delivery item entrusted to the delivery agency; and wherein the delivery agency's cryptogram reader decrypts the output recipient's encryption information using the delivery agency's secret key so that the delivery agency obtains the recipient information.

Since the invention mentioned above uses the public key to encrypt the recipient's private information, it is possible to deliver an item without disclosing the private information to the sender. In this case, it is unnecessary to use a database for storing private information about the recipient or the sender, maximally preventing a leak of the private information. If an encryption key is stolen, it is possible to limit the leak of secrets to that of the private information about the delivery item that uses the stolen encryption key. It is possible to not only save labors for the server management, but also reduce costs for providing a delivery system that can conceal the private information. Moreover, the delivery agency need not inquire a server apparatus, making it possible to convert the destination offline.

The recipient's terminal apparatus attaches information about the delivery agency's public key to the recipient's encryption information and transmits it to the sender's terminal apparatus. In this configuration, the delivery agency can reference the information and use a plurality of pairs of public keys and secret keys.

The sender's terminal apparatus obtains a public key of the delivery agency from the delivery agency server apparatus or via a specified medium, uses the public key to encrypt sender information about a sender to generate sender's encryption information, and outputs the sender's encryption information to be attached to a delivery item entrusted to the delivery agency. The delivery agency's cryptogram reader decrypts the output sender's encryption information using the delivery agency's secret key so that the delivery agency obtains the sender information. In this configuration, the delivery agency can identify the sender's private information without permitting the recipient to know the sender's private information.

The recipient's encryption information comprises at least coded information. In this configuration, the recipient's encryption information (or the sender's encryption information as needed) comprises coded information such as a bar or a two-dimensional bar code. The cryptogram reader can be used to easily and automatically recognize the recipient information (or the sender information as needed).

An output of the recipient's encryption information contains at least a name identifying the recipient. In this configuration, it is possible to identify the recipient (or the sender as needed) without disclosing the recipient's real name (or the sender's real name as needed).

According to a fifth aspect of the present invention in order to solve the above-mentioned problems, there is provided a program for a computer of a delivery agency which delivers a delivery item entrusted by a sender to a recipient, wherein a public switched telephone network is used to make connection between a sender's terminal apparatus of the sender entrusting delivery of the delivery item to the delivery agency and a recipient's terminal apparatus of the recipient receiving the delivery item, and the program allows the computer to function as: a public key management means for managing a public key to execute an encryption program which encrypts recipient information containing at least recipient's private information needed for delivery of delivery items; a public key transmission means for transmitting the public key to the recipient's terminal apparatus in response to a request from the recipient's terminal apparatus; a secret key management means for managing a secret key to decrypt recipient's encryption information encrypted and generated by the encryption program using the public key from recipient information containing at least recipient's private information needed for delivery of delivery items; and a secret key provision means for providing the secret key to a cryptogram reader which decrypts the recipient's encryption information.

According to a sixth aspect of the present invention in order to solve the above-mentioned problems, there is provided a computer-readable storage medium recording a program for a computer of a delivery agency which delivers a delivery item entrusted by a sender to a recipient, wherein a public switched telephone network is used to make connection between a sender's terminal apparatus of the sender entrusting delivery of the delivery item to the delivery agency and a recipient's terminal apparatus of the recipient receiving the delivery item, and the program allows the computer to function as: a public key management means for managing a public key to execute an encryption program which encrypts recipient information containing at least recipient's private information needed for delivery of delivery items; a public key transmission means for transmitting the public key to the recipient's terminal apparatus in response to a request from the recipient's terminal apparatus; a secret key management means for managing a secret key to decrypt recipient's encryption information encrypted and generated by the encryption program using the public key from recipient information containing at least recipient's private information needed for delivery of delivery items; and a secret key provision means for providing the secret key to a cryptogram reader which decrypts the recipient's encryption information.

### BRIEF DESCRIPTION OF THE DRAWINGS

FIG. 1 is a block diagram showing an item delivery system according to a first embodiment;

FIG. 2 is a block diagram showing a configuration of a recipient's terminal apparatus according to the first embodiment;

FIG. 3 is a block diagram showing a configuration of a sender's terminal apparatus according to the first embodiment;

FIG. 4 is a block diagram showing a configuration of a delivery agency server apparatus according to the first embodiment;

FIG. 5 is a schematic diagram showing an item delivery method according to the first embodiment;

FIG. 6 is a flowchart showing the item delivery method according to the first embodiment;

FIG. 7 is a schematic diagram showing an item delivery method when encrypting sender's information according to the first embodiment;

FIG. 8 is a schematic diagram showing a first encryption method according to the first embodiment;

FIG. 9 is a flowchart showing the first encryption method according to the first embodiment;

FIG. 10 is an explanatory diagram showing a computer screen for the first encryption method;

FIG. 11 is an explanatory diagram showing a computer screen for the first encryption method;

FIG. 12 is an explanatory diagram showing a computer screen for the first encryption method;

FIG. 13 is a schematic diagram showing a first encryption method according to a second embodiment;

FIG. 14 is a flowchart showing the first encryption method according to the second embodiment;

FIG. 15 is an explanatory diagram showing a computer screen for the second encryption method;

FIG. 16 is an explanatory diagram showing a computer screen for the second encryption method;

FIG. 17 is an explanatory diagram showing a computer screen for the second encryption method;

FIG. 18 is an explanatory diagram showing an example of labeling recipient's encryption information;

FIG. 19 is an explanatory diagram showing an example of labeling recipient's encryption information and sender's encryption information;

FIG. 20 is an explanatory diagram showing a method of decrypting recipient's information according to the first embodiment;

FIG. 21 is a flowchart showing the method of decrypting recipient's information according to the first embodiment;

FIG. 22 is an explanatory diagram showing a delivery system in which a delivery agency performs delivery via a service agent; and

FIG. 23 is an explanatory diagram showing a delivery system in which a plurality of delivery agencies performs delivery.

### DETAILED DESCRIPTION OF THE PREFERRED EMBODIMENTS

Embodiments of the present invention will be described in further detail with reference to the accompanying drawings. To omit the duplicate description, this specification and drawings thereof designate the same reference numeral to components having substantially the same functional configuration.

### First Embodiment

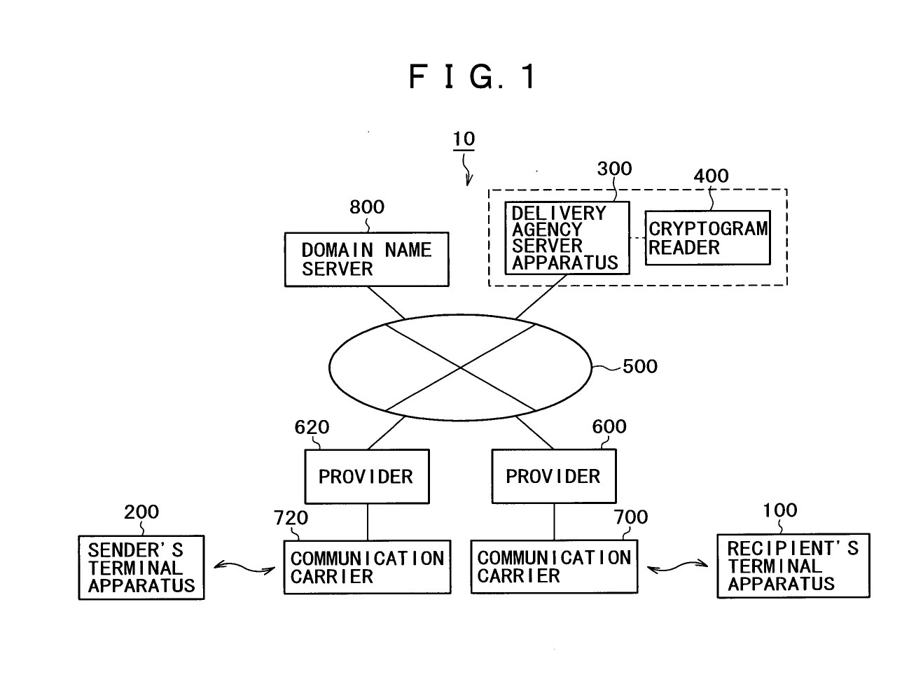

Referring now to FIG. 1, the following describes an item delivery system according to the embodiment. FIG. 1 is a block diagram showing the item delivery system according to the embodiment.

As shown in FIG. 1, an item delivery system 10 according to the embodiment connects with a recipient's terminal apparatus 100, a sender's terminal apparatus 200, a delivery agency server apparatus 300, and the like via the Internet and the like. The delivery agency server apparatus 300 is a server apparatus of an agency that provides item delivery services. The delivery agency server apparatus 300 can be connected to a cryptogram reader 400 so as to be capable of data transfer. The recipient's terminal apparatus 100 and the sender's terminal apparatus 200 are connected to each other via providers 600 and 620 and communication carriers 700 and 720.

A domain name server 800 interchanges a domain name and an IP address. The domain name server 800 retrieves the IP address from a URL transmitted from the recipient's terminal apparatus 100 or the sender's terminal apparatus 200 and returns that IP address to the recipient's terminal apparatus 100 or the sender's terminal apparatus 200.

The providers 600 and 620 logically connect a network 500 with the recipient's terminal apparatus 100 that is connected via the communication carriers 700 and 720. The providers 600 and 620 transmit information between the recipient's terminal apparatus 100 and the network 500 and between the sender's terminal apparatus 200 and the same. The communication carriers 700 and 720 correspond to transmission media provided by communication service companies such as NTT. The communication carriers 700 and 720 can provide connection and transmit information between the recipient's terminal apparatus 100 and the provider 600 and between the sender's terminal apparatus 200 and the provider 620, respectively.

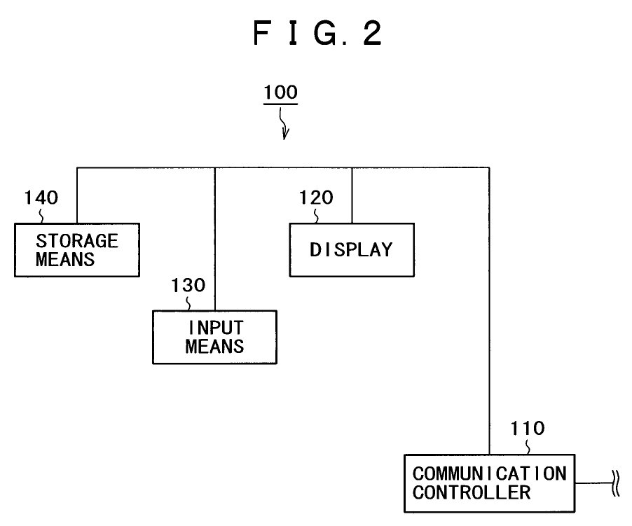

As shown in FIG. 2, the recipient's terminal apparatus 100 comprises, for example, a communication controller 210 for controlling communication with the delivery agency server apparatus 300; a display means (display) 120 for displaying contents transmitted from the delivery agent server apparatus 300; an input means 130 for entering various data such as information data; and a storage means 140 for storing information transmitted from the delivery agent server apparatus 300. The storage means 140 also can store an encryption program, public keys, and the like transmitted from the delivery agent server apparatus 300. The recipient's terminal apparatus 100 represents not only desktop computers, notebook computer, and portable terminals, but also cellular phones having browser capabilities such as i-mode (trade name) and terminals having communication capabilities such as Palm OS devices.

The recipient information comprises at least recipient's private information needed for delivery of items. Using a delivery agency's public key, the recipient's terminal apparatus 100 encrypts the recipient information by executing the previously downloaded delivery agency's encryption program. The encrypted recipient information is transmitted as recipient's encryption information to the sender's terminal apparatus 200.

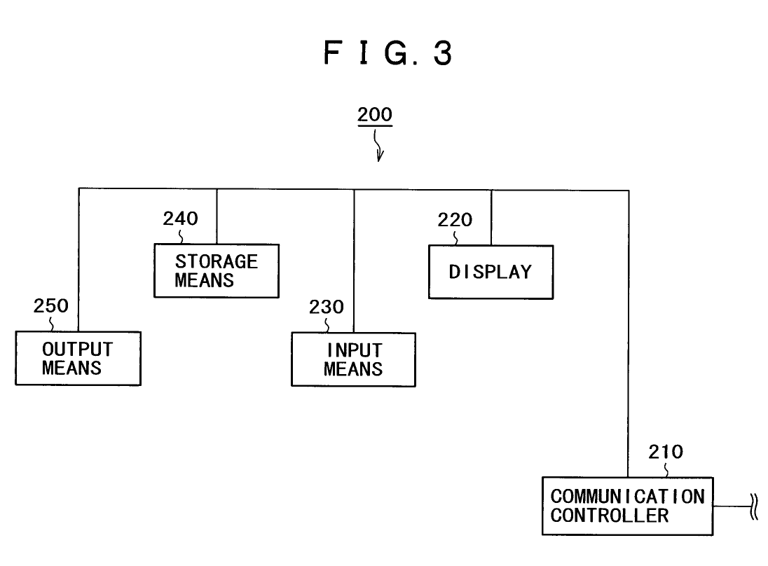

As shown in FIG. 3, the sender's terminal apparatus 200 comprises, for example, a communication controller 210 for controlling communication with the delivery agent server apparatus 300; a display means (display) 220 for displaying contents sent from the delivery agent server apparatus 300; an input means 230 for entering various data such as information data; a storage means 240 for storing information sent from delivery agent server apparatus 300; and an output means 250 for outputting recipient's encryption information by means of label printing.

The storage means 240 can also store an encryption program, public keys, and the like transmitted from the delivery agent server apparatus 300. The output means 250 not only prints the recipient's encryption information on labels, but also records the information on various media such as magnetic cards and IC cards. The recipient's terminal apparatus 200 represents not only desktop computers, notebook computer, and portable terminals, but also cellular phones having browser capabilities such as i-mode (trade name) and terminals having communication capabilities such as Palm OS devices.

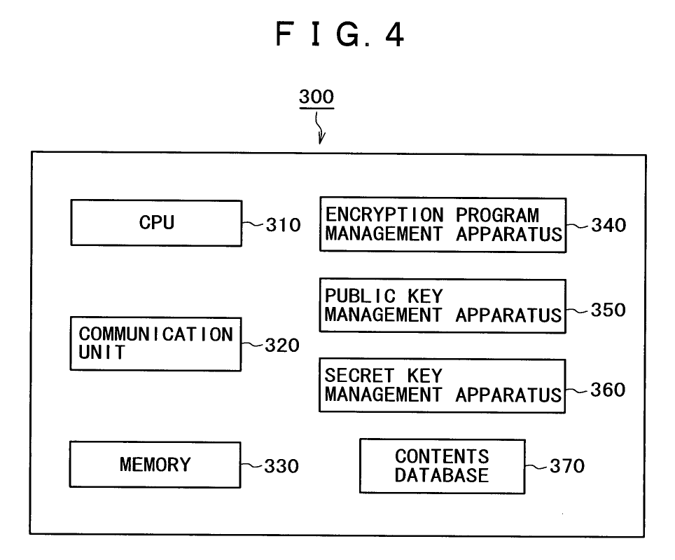

Referring now to FIG. 4, the delivery agent server apparatus according to the embodiment will now be described. FIG. 4 is a block diagram showing a configuration of the delivery agent server apparatus according to the embodiment. Unlike the prior art, the delivery agent server apparatus according to the embodiment has no database for storing private information about recipients or senders.

As shown in FIG. 4, the delivery agent server apparatus 300 according to the embodiment comprises, for example, a CPU 310; a communication unit 320; a memory 330; an encryption program management means 340; a public key management means 350; secret key management means 360; and contents database 370.

The CPU 310 provides overall control of the delivery agent server apparatus 300. The communication unit 320 controls communication with the outside via a telephone line or the Internet. The memory 330 stores programs and data accessed by the CPU 310.

The encryption program management apparatus 340 stores a program for encrypting the recipient information or the sender information. The public key management apparatus 350 manages public keys for executing the encryption program. The secret key management means 360 manages secret keys for decrypting the encrypted recipient information or sender information.

The contents database 370 stores contents such as hypertext objects including HTML files, graphical icon files (e.g., GIF files), sound and image objects provided from the delivery agent server apparatus 300. These objects are supplied to the recipient's terminal apparatus 100 and the sender's terminal apparatus 200 via the Internet, for example.

The cryptogram reader 400 has, for example, a scanning function to read recipient's encryption information; a secret key storage function to store a downloaded secret key; a decryption function to decrypt the read recipient's encryption information; and a label printing function to print the decrypted recipient information on a label. For example, the cryptogram reader 400 includes a hand-held bar code scanner having the label printing function. The cryptogram reader 400 can download secret keys by connecting to the delivery agent server apparatus 300.

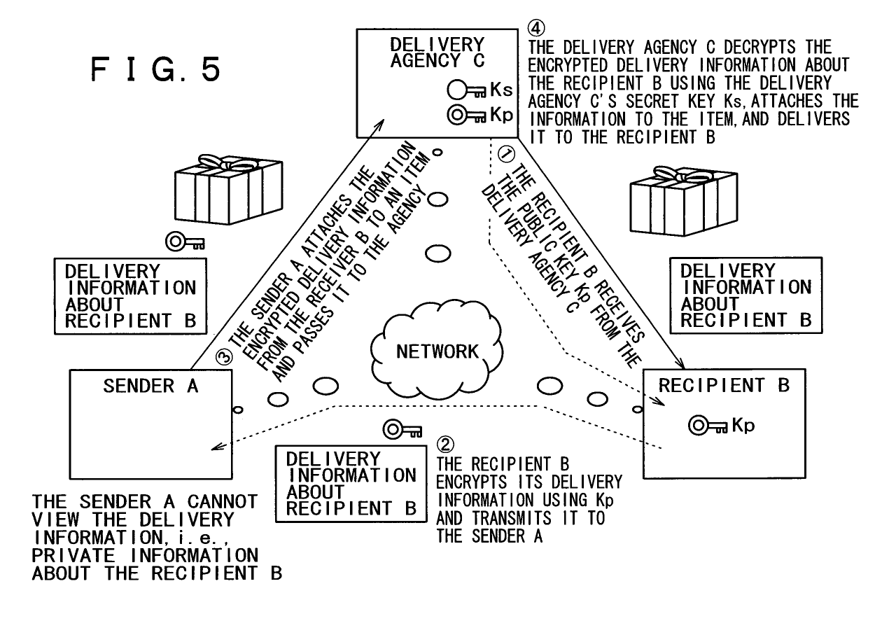

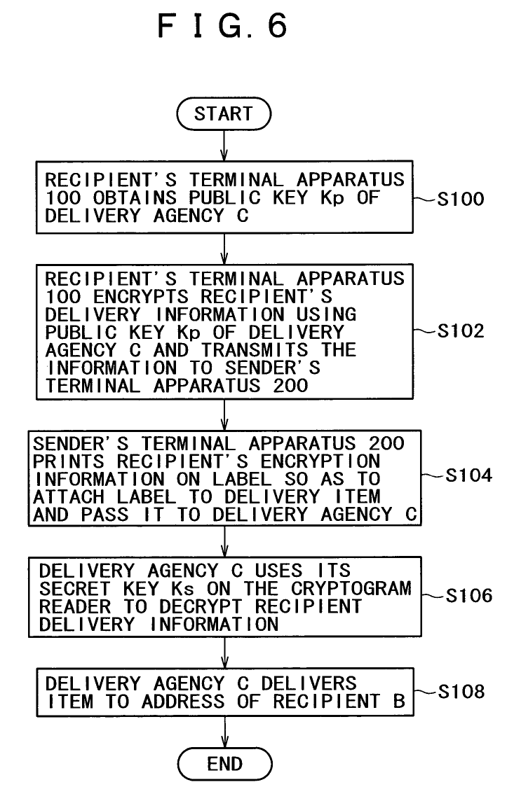

With reference to FIG. 5, the following describes the method of delivering items based on FIG. 6. FIG. 5 is a schematic diagram showing an item delivery method according to the embodiment. FIG. 6 is a flowchart showing the item delivery method according to the embodiment.

The embodiment describes a case where users have concluded a sales contract of an item using the Internet and the item is delivered between them. In this case, a recipient receives the item delivered by a delivery agency. A sender is a person or an agency that owns, sales, or lends items. The sender sends items to the recipient. It is assumed that an encryption program is already downloaded to the recipient's terminal apparatus.

As shown in FIG. 6, at step S100, the recipient's terminal apparatus 100 obtains a public key Kp of a delivery agency C (step S100)

At step S102, the recipient's terminal apparatus 100 uses the obtained public key Kp and the already downloaded encryption program to encrypt delivery information (address, name, telephone number, etc.) about the recipient as an item delivery destination. The encrypted information may be bar-coded, for example, and is transmitted to the sender's terminal apparatus 300 through an electronic means such as electronic mail (step S102).

At step S104, the sender's terminal apparatus 200 prints the recipient's encryption information on a label, for example. The label containing the encrypted recipient information is attached to a delivery item which is then passed to a delivery agency C for delivery (step S140).

At step S106, the delivery agency C uses its secret key Ks on the cryptogram reader (e.g., bar code scanner) 400 to decrypt the recipient delivery information. The delivery agency C then prints a label that visibly shows the delivery destination of the recipient B (step S106). The label visibly showing the delivery destination of the recipient B replaces the encrypted label that is already attached.

Finally, at step S106, the delivery agency C delivers the item to the address of the recipient B indicated on the label. The recipient B can receive the item (step S106).

The embodiment encrypts the delivery information (address, name, telephone number, etc.) of the recipient B and transmits that information to the sender A. The recipient information is concealed from the sender A that does not have the secret key. In this manner, the item is delivered to the recipient B without private information of the recipient B not being disclosed to the sender A.

In the above-mentioned item delivery system, there has been described the example of only encrypting the recipient information. Alternatively, it is possible to encrypt the private information of the sender A. The delivery agency needs to know identification information about the sender such as the address and name for the reason of managing the delivery history or the like. In this case, if the private information (address, name, etc.) about the sender A is attached to the delivery item, the private information about the sender A is disclosed to the recipient. To solve this problem, the sender A can encrypt its private information in the same manner as that for encrypting the recipient information using the sender's terminal apparatus 200. The sender A can notify its private information to the delivery agency C without disclosing that information to the recipient B.

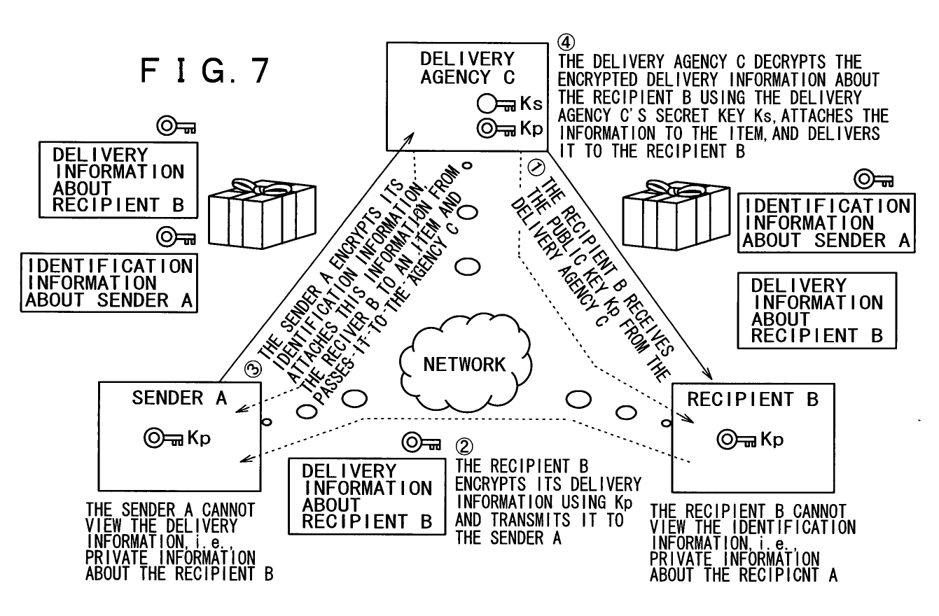

This will be described concisely with reference to FIG. 7. Like FIG. 5, the recipient's encryption information is transmitted to the sender's terminal apparatus 200 from the recipient's terminal apparatus 100.

As shown in FIG. 7, the sender's terminal apparatus 200 executes the encryption program to encrypt the identification information of the sender A (i.e., the sender information such as the address and name) using the public key Kp of the delivery agency C and generate sender's encryption information. This information is printed on, e.g., a label together with the recipient's encryption information. The sender A attaches the printed label containing the sender's encryption information and the recipient's encryption information to a delivery item and passes it to the delivery agency C.

In this manner, the delivery agency C can use its secret key Ks to obtain the private information about the sender A. However, the private information of the sender A is not disclosed to the recipient B that does not own the secret key Ks.

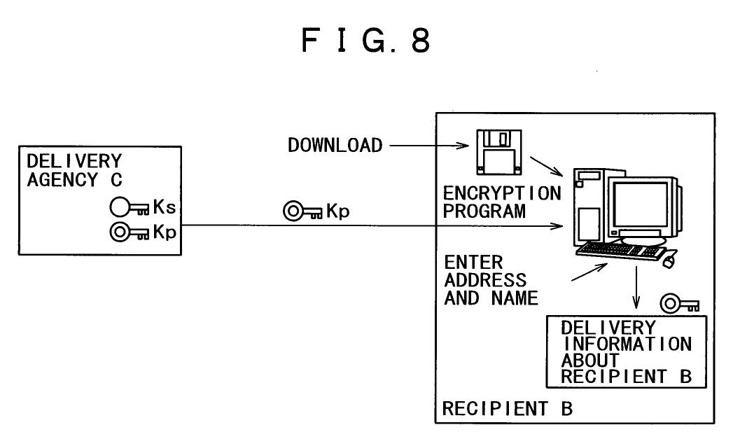

The following describes in more detail each process of the item delivery method according to the embodiment with reference to FIGS. 8 through 21. In this embodiment, the description below is categorized into: (1) encrypting the recipient information; (2) labeling the recipient's encryption information and the sender's encryption information; and (3) decrypting the recipient's encryption information.

(1) Encrypting the Recipient Information

The following describes in detail the method of encrypting the recipient information according to the embodiment with reference to FIGS. 8 through 17.

For example, there are two types of methods of encrypting the recipient information. The first encryption method encrypts the recipient information using an encryption program stored in the recipient's terminal apparatus. The second encryption method encrypts the recipient information using an encryption program stored in the delivery agency server apparatus.

(First Encryption Method Using the Encryption Program Stored in the Recipient's Terminal Apparatus)

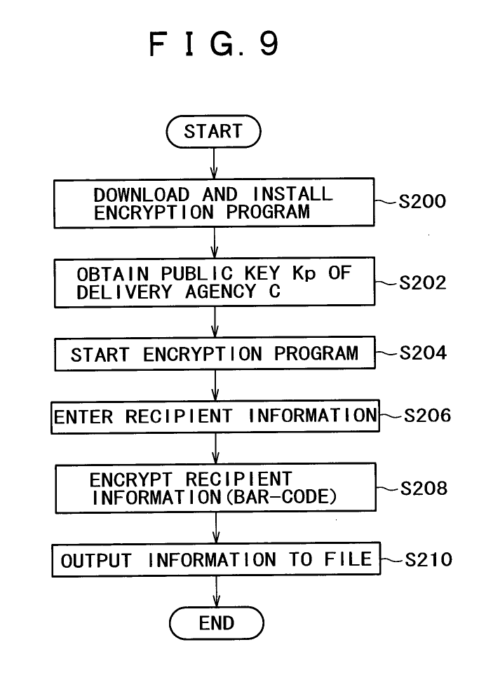

Referring now to FIGS. 8 through 13, the following describes the first method of encrypting recipient's delivery information according to the embodiment. FIG. 8 is a schematic diagram showing the first method of encrypting the recipient information according to the embodiment. FIG. 9 is a flowchart showing the first method of encrypting the recipient information according to the embodiment.

At step S200 as shown in FIG. 9, the recipient's terminal apparatus 100 downloads an encryption software program from an Internet site of the delivery agency C and installs the program (step S200). Such encryption program can be distributed as a supplement to a magazine (e.g., CD-ROM).

At step S202 as shown in FIG. 8, the recipient's terminal apparatus 100 downloads to obtain the public key Kp of the delivery agency C (step S202). The public key is needed for executing the recipient information encryption program according to the embodiment.

When the encryption software is activated at step S204, the recipient's terminal apparatus 100 shows a screen for entering the information about the recipient B (step S204).

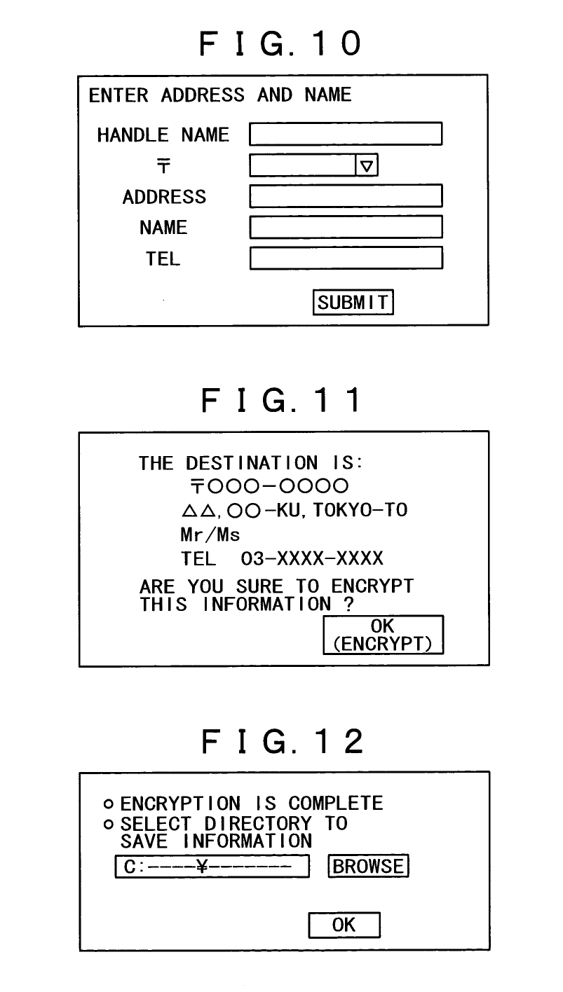

As shown in FIG. 10, the recipient information input screen provides, input items such as “Handle name”, “Address”, “Name”, and “Telephone number” and the “Submit” button.

At step S206, a user fills in necessary fields on an input screen for the delivery information about the recipient B (step S206). The “Handle name” field should contain a specified name that identifies the recipient. The “Address” field should contain a recipient's address to which the item is delivered. The “Name” field should contain the recipient's name. The “Telephone number” field should contain the recipient's telephone number. The “Submit” button is used for confirming the recipient information before it is encrypted.

After the necessary fields are entered, clicking the Submit button displays a confirmation screen for the recipient information as shown in FIG. 11. The “OK (encrypt)” button is used to start encrypting the recipient information.

At step S208, clicking the encryption button on the recipient information confirmation screen encrypts the recipient information (step S208). The recipient information can be encrypted into a hexadecimal text code, for example. In consideration for convenience of the delivery, however, it is preferable to encode the recipient information into a bar code or a two-dimensional bar code, for example. The coded information such as bar codes can allow the cryptogram reader to easily and automatically identify the recipient's encryption information.

Finally at step S210, a file for the recipient's encryption information is generated in a directory specified by the recipient's terminal apparatus 100. To specify the directory, the user specifies a directory to save the encrypted file on the directory specification screen, and then clicks the “OK” button as shown in FIG. 12. An encrypted information file may comply with image file formats such as GIF, JPEG, and BMP or document file formats such as WORD and PDF. It is preferable to create the encrypted information as simple binary data to be output in consideration for concatenation with the sender's encryption information (code information) as a subsequent process.

It is preferable that the generated file contains not only the recipient's encryption information, but also a name for identifying the recipient such as a handle name, a mail address that can be made public, and the like.

In this manner, the encryption program stored in the recipient's terminal apparatus is used to encrypt the recipient information which can be then saved in a directory specified by the recipient B.

(Second Encryption Method by Storing the Encryption Program in the Delivery Agent Server Apparatus)

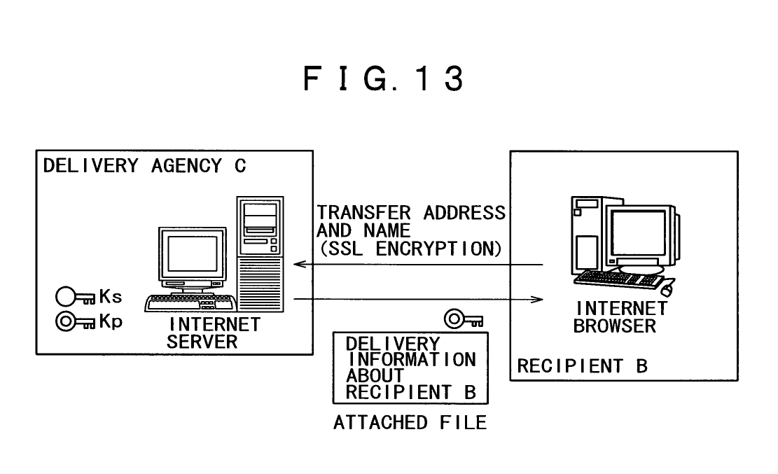

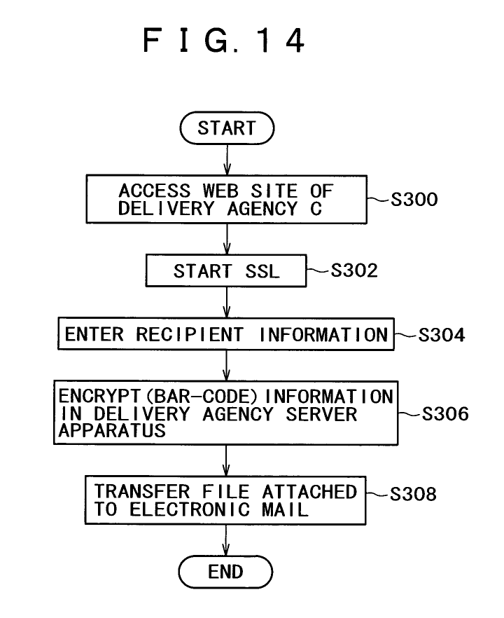

With reference to FIGS. 13 through 17, the following describes the second method of encrypting the delivery information about a recipient according to the embodiment. FIG. 13 is a schematic diagram showing the second method of encrypting the recipient information according to the embodiment. FIG. 14 is a flowchart showing the second method of encrypting the recipient information according to the embodiment.

At step S300, the recipient's terminal apparatus 100 uses an ordinary Internet browser to access the Web site of the delivery agency C (step S300).

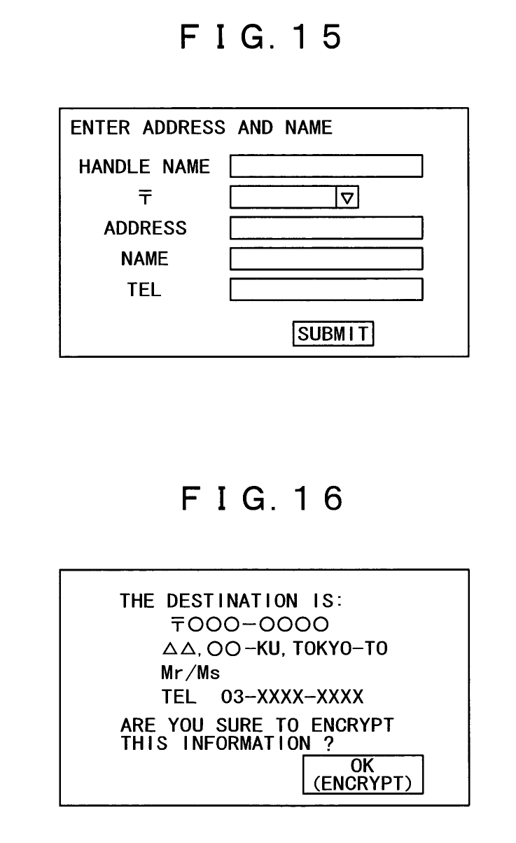

At step S302, the recipient proceeds to an SSL-enabled page (recipient information input page) so as to use the item delivery system according to the embodiment, and then clicks an SSL start button (not shown) to start the SSL (step S302). With the encryption communication enabled in this manner, the recipient can use the item delivery system according to the embodiment. As shown in FIG. 15, the recipient information input screen displays input fields such as “Handle name”, “Address”, “Name”, and “Telephone number” and the “Submit” button.

At step S304, the recipient fills in the specified fields of the recipient information input screen on the display (step S304). The “Handle name” field should contain a specified name that identifies the recipient. The “Address” field should contain a recipient's address to which the item is delivered. The “Name” field should contain the recipient's name. The “Telephone number” field should contain the recipient's telephone number. The “Submit” button is used for confirming the recipient information before it is encrypted.

After the necessary fields are entered, clicking the “Submit” button displays a confirmation screen for the recipient information as shown in FIG. 16. The “OK (encrypt)” button is used to start encrypting the recipient information.

At step S306, clicking the encryption button on the recipient information confirmation screen transfers the recipient information to the delivery agent server apparatus to execute the encryption (step S306). The recipient information can be encrypted into a hexadecimal text code, for example. In consideration for convenience of the delivery, however, it is preferable to encode the recipient information into a bar code or a two-dimensional bar code, for example. The coded information such as bar codes can allow the cryptogram reader to easily and automatically identify the recipient's encryption information.

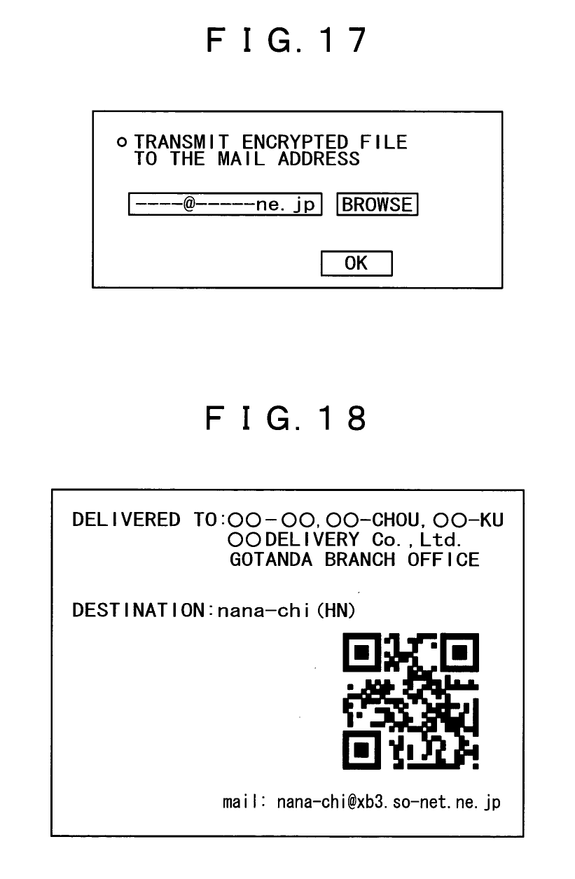

At step S308 as shown in FIG. 13, the file is transmitted to the mail address specified by the recipient's terminal apparatus 100 (step S308). The mail address specification screen as shown in FIG. 17 can be used to specify a mail address for transmitting the encrypted file. Then, clicking the “OK” button transmits the encrypted file. An encrypted information file may comply with image file formats such as GIF, JPEG, and BMP or document file formats such as WORD and PDF. It is preferable to create the encrypted information as simple binary data to be output in consideration for concatenation with the sender's encryption information (code information) as a subsequent process.

In this manner, the recipient information is encrypted through the use of the encryption program stored in the delivery agent server apparatus and is transmitted to the mail address specified by the recipient B. Alternatively, the encrypted file can be placed on the site. The recipient's terminal apparatus can obtain the encrypted information by downloading the encrypted file by means of ftp or http.

(2) Labeling the Recipient's Encryption Information and the Sender's Encryption Information

As mentioned above, the encrypted recipient information is transmitted from the recipient's terminal apparatus to the sender's terminal apparatus for label printout.

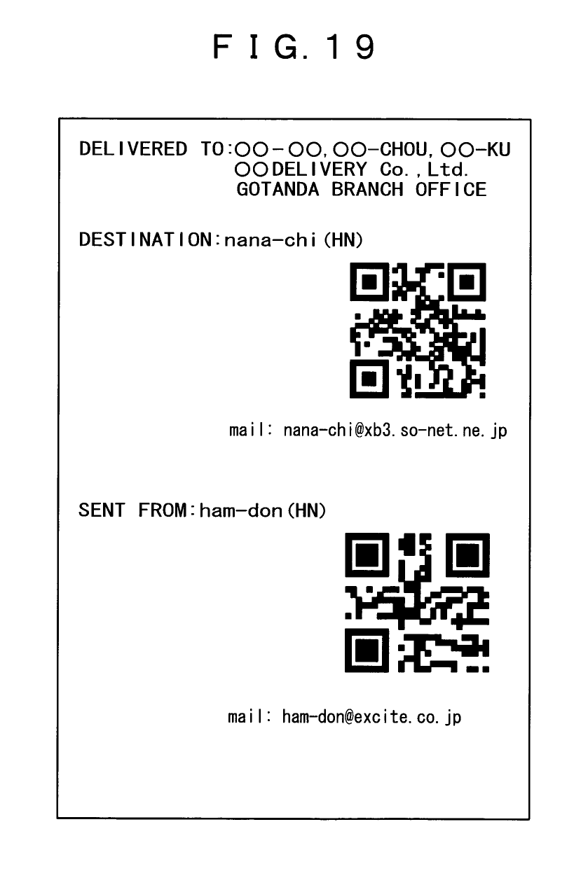

Examples of such label will now be described with reference to FIGS. 18 and l9. FIG. 18 shows an example of labeling recipient's encryption information; FIG. 19 shows an example of labeling recipient's encryption information and sender's encryption information.

As shown in FIG. 18, a delivery label contains the recipient's encryption information and provides “Delivered to” and “Destination” fields. The “Delivered to” field describes the delivery agency's address, company name, and branch office name. The “Destination” field describes the handle name (HN) as a name identifying the recipient, the encrypted recipient information, and mail address. In this manner, the label shows the information about the recipient's destination in an encrypted form, preventing the recipient's private information from being made public.

It is also possible to indicate the sender's encryption information together with the recipient's encryption information on the label. In this case, as shown in FIG. 19, the label shows “Delivered to”, “Destination”, and “Sent from” fields. The “Delivered to” field describes the delivery agency's address, company name, and branch office name. The “Destination” field describes the handle name (HN) as a name identifying the recipient, the encrypted recipient information, and mail address. The “Sent from” field describes the handle name (HN) as a name identifying the sender, the encrypted recipient information, and the mail address. In this manner, the label shows the information about the recipient's destination and the sender's private information in an encrypted form, preventing the private information about the sender and the recipient from being made public.

(3) Decrypting the Recipient's Encryption Information

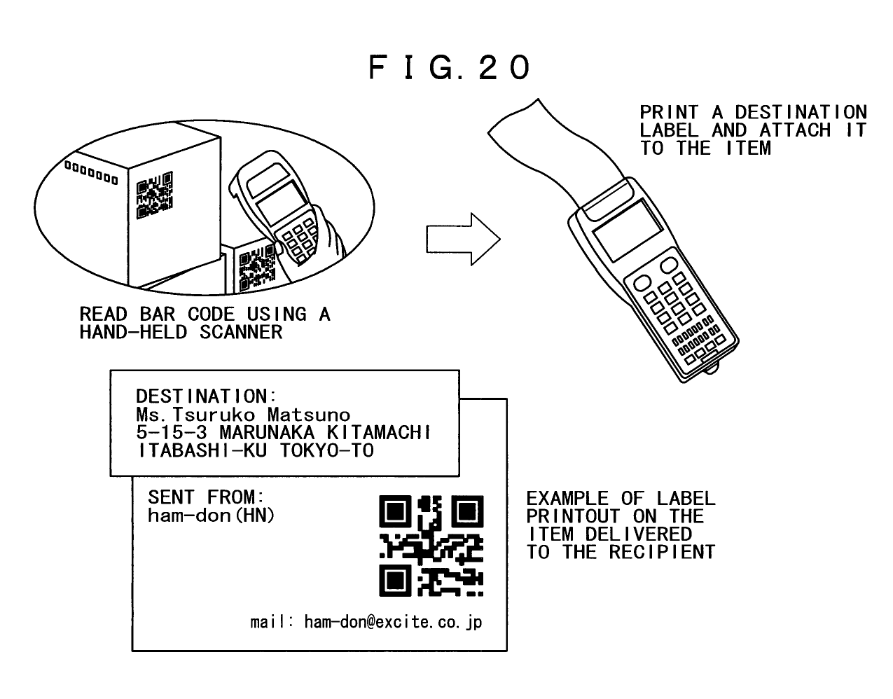

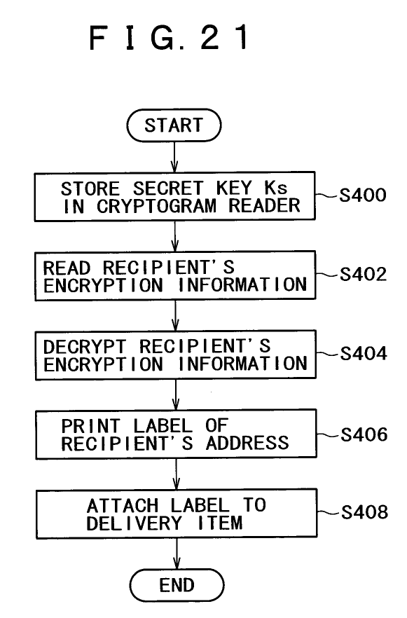

The following describes the method of decrypting the recipient information with reference to FIGS. 20 and 21. FIG. 20 is an explanatory diagram showing the method of decrypting recipient's information according to the embodiment. FIG. 21 is a flowchart showing the method of decrypting recipient's information according to the embodiment.

At step S400, the cryptogram reader (e.g., hand-held bar code scanner) retrieves the secret key Ks from the delivery agent server apparatus (step S400).

At step S402, the delivery agency C reads the recipient's encryption information (code data) from the label attached to the delivery item using the cryptogram reader (step S402).

At step S404 as shown in FIG. 20, the cryptogram reader decrypts the scanned recipient's encryption information using the delivery agency C's secret key to obtain the recipient's destination information (step S404).

At step S406 as shown in FIG. 20, the cryptogram reader uses its print function to print the recipient's destination on a label (step S406).

Finally, at step S408 as shown in FIG. 20, the printed label is attached to a delivery item (step S408).

In this manner, the delivery agency C can obtain the recipient B's destination and deliver the item.

The cryptogram reader may be a hand-held printer-equipped reader and may be mounted on an automatic conveyer for mass processing. When the cryptogram reader is a stationary device, it is preferable to download a secret key via a network. When a plurality of secret keys is used, it is preferable to update the keys. When the cryptogram reader is a hand-held device, it is preferable to take an opportunity for updating key information at the time of recharging once a day, for example.

The embodiment uses the public key to encrypt private information about the recipient or, if needed, about the sender. Accordingly, items can be delivered without disclosing the private information to the other party (sender or recipient). This eliminates the need for a database that stores the private information about the recipient or the sender, maximally preventing a leak of the private information. Further, the delivery agent server apparatus does not need a database for managing the recipient information. It is possible to not only save labors for the server management, but also reduce costs for providing a delivery system that can conceal the private information. Moreover, the delivery agency need not inquire a server apparatus, making it possible to convert the destination offline. Furthermore, a user need not individually manage his or her ID number.

While there has been described the preferred embodiments of the present invention, the present invention is not limited thereto. It is further understood by those skilled in the art that various changes and modifications may be made in the present invention without departing from the spirit and scope thereof. It is also understood that the changes and modifications may be included in the technical scope of the present invention.

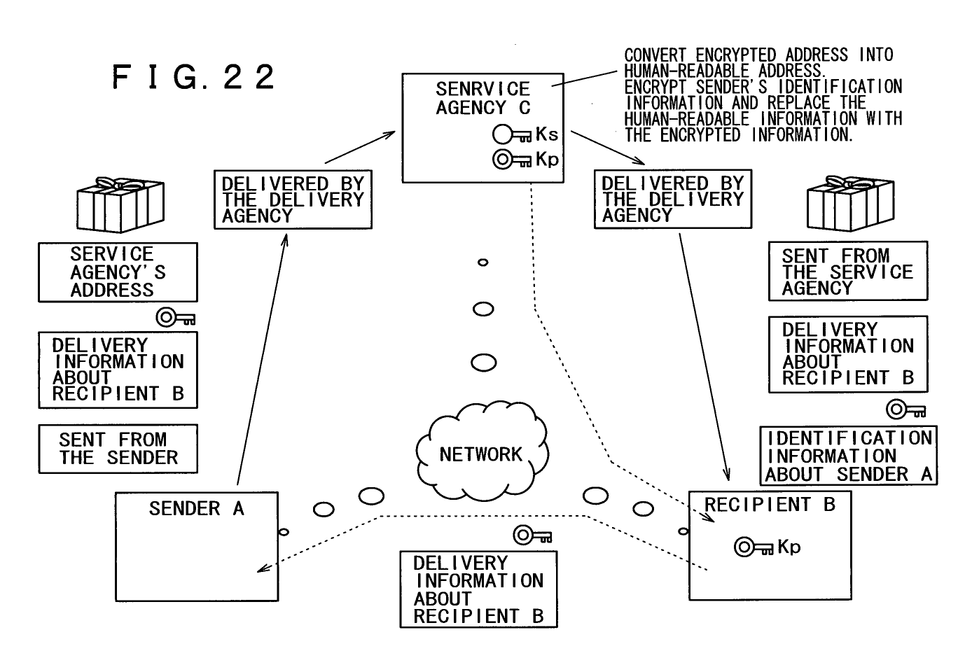

For example, the above-mentioned embodiments have described the examples in which the delivery agency C provides services of encrypting and decrypting the recipient information or the sender information. In addition, an appropriate professional agency may be responsible for such services. In this case, the delivery agency conducts delivery works via the service agency. As shown in FIG. 22, for example, the recipient B encrypts the recipient information using a service agency C's public key. The service agency decrypts the recipient's encryption information and attaches a label to a delivery item. The service agency also encrypts the sender's identification information and replaces the human-readable information with the encrypted information. The sender's human-readable information is passed to the delivery agency.

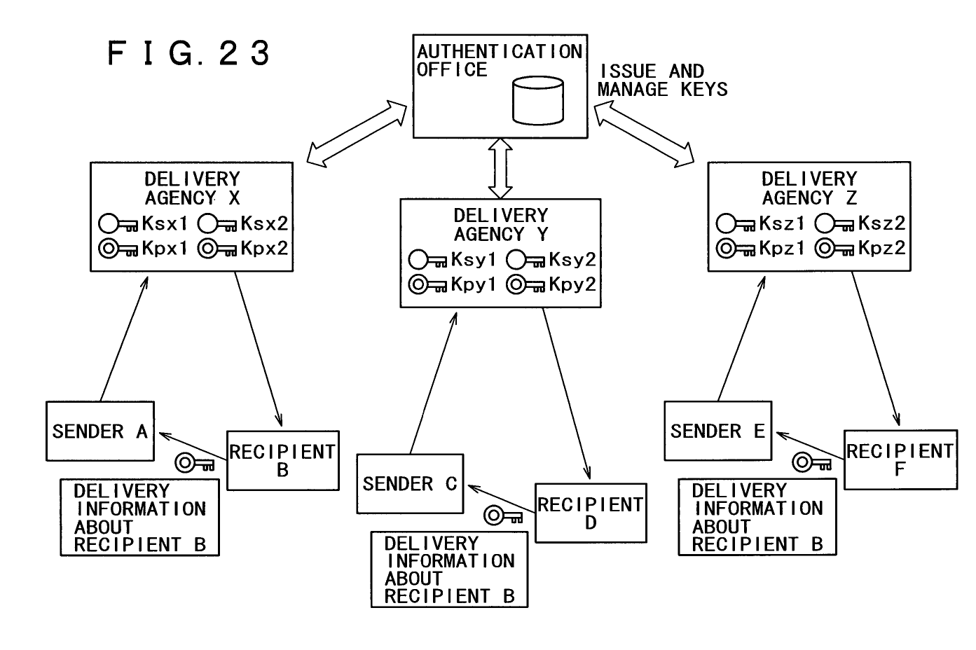

While the embodiments have described the examples in which the single delivery agency provides delivery services, the present invention is not limited thereto. A plurality of delivery agency can be responsible for delivery services. In this case, as shown in FIG. 23, an authentication office manages public keys and secret keys and issues public key certificates to each delivery agency. In this manner, it is possible to enable the common use of the encryption software and unify the management.

While the embodiments have described the examples in which the delivery agency owns a single key, the present invention is not limited thereto. The same delivery agency can own a plurality of keys. Also in this case, the authentication office of public keys and secret keys manages the delivery agency's keys. If the secret key leaks out, the authentication office can nullify the secret key. When a plurality of keys is available, a possible risk can be diversified. In this case, the encrypted delivery information can be easily decrypted by providing it with the public key's number or certificate used for the encryption.

While the embodiments have described the examples in which the recipient's terminal apparatus transmits an encrypted file to the sender's terminal apparatus via the network, the present invention is not limited thereto. It is also possible to pass electronic data or a printout result directly to the sender without intermediation of the network.

While the embodiments have described the examples in which the sender's terminal apparatus prints the recipient's encryption information on a label, the present invention is not limited thereto. For example, the recipient's encryption information may be stored on various media such as magnetic cards and IC cards which can be then handed to the delivery agency.

While the embodiments have described the examples in which the recipient's terminal apparatus downloads the delivery agency's public key for encryption from the delivery agency's site, the present invention is not limited thereto. For example, it is possible to previously store the public key on the encryption program for distribution.

Since the public key is used to encrypt the recipient's private information or the sender's private information as needed, it is possible to deliver items without making the private information known to the other party (sender or recipient). There becomes no need for the database for storing the private information of the recipient or the sender, maximally preventing a leak of the private information. It is possible to not only save labors for the server management, but also reduce costs for providing a delivery system that can conceal the private information. Moreover, the delivery agency need not inquire a server apparatus, making it possible to convert the destination offline. Furthermore, a user need not individually manage his or her ID number. If the authentication office is configured to manage keys, a plurality of delivery service agencies can use the common infrastructure.

What is claimed is:

1. An item delivery system in which a public switched telephone network is used to make connection between a sender's terminal apparatus of a sender entrusting delivery of a delivery item to a delivery agency and a recipient's terminal apparatus of a recipient receiving the delivery item,
wherein the recipient's terminal apparatus obtains a public key of the delivery agency via a specified medium, uses the public key to encrypt recipient information containing at least recipient's private information needed for delivery of items and to generate recipient's encryption information, and transmits the recipient's encryption information to the sender's terminal apparatus;
wherein the sender's terminal apparatus outputs the transmitted recipient's encryption information in order to be attached to a delivery item entrusted to the delivery agency; and
wherein the delivery agency's cryptogram reader decrypts the output recipient's encryption information using the delivery agency's secret key so that the delivery agency obtains the recipient information.

2. The item delivery system according to claim 1, wherein the recipient's terminal apparatus attaches information about the delivery agency's public key to the recipient's encryption information and transmits it to the sender's terminal apparatus.

3. The item delivery system according to claim 1,
wherein the sender's terminal apparatus obtains a public key of the delivery agency via a specified medium, uses the public key to encrypt sender information about a sender to generate sender's encryption information, and outputs the sender's encryption information to be attached to a delivery item entrusted to the delivery agency; and
wherein the delivery agency's cryptogram reader decrypts the output sender's encryption information using the delivery agency's secret key so that the delivery agency obtains the sender information.

4. The item delivery system according to claim 1, wherein the recipient's encryption information contains at least coded information.

5. The item delivery system according to claim 1, wherein an output of the recipient's encryption information contains at least a name identifying the recipient.

6. A delivery agency server apparatus of a delivery agency which delivers a delivery item entrusted by a sender to a recipient, wherein a public switched telephone network is used to make connection between a sender's terminal apparatus of the sender entrusting delivery of the delivery item to the delivery agency and a recipient's terminal apparatus of the recipient receiving the delivery item, and the delivery agent server apparatus comprises:
a public key management means for managing a public key to execute an encryption program which encrypts recipient information containing at least recipient's private information needed for delivery of delivery items;
a public key transmission means for transmitting the public key to the recipient's terminal apparatus in response to a request from the recipient's terminal apparatus;
a secret key management means for managing a secret key to decrypt recipient's encryption information encrypted and generated by the encryption program using the public key from recipient information containing at least recipient's private information needed for delivery of delivery items; and
a secret key provision means for providing the secret key to a cryptogram reader which decrypts the recipient's encryption information.

7. The delivery agent server apparatus according to claim 6,
wherein the public key transmission means can transmit the public key to the sender's terminal apparatus in response to a request from the sender's terminal apparatus;
wherein the encryption program can use the public key to encrypt sender information about the sender and generate sender's encryption information; and
wherein the secret key can decrypt the sender's encryption information.

8. The item delivery system according to claim 6, wherein an output of the recipient's encryption information contains at least a name identifying the recipient.

9. A cryptogram reader connectable to a delivery agency server apparatus of a delivery agency which delivers a delivery item entrusted by a sender to a recipient, wherein a public switched telephone network is used to make connection between a sender's terminal apparatus of the sender entrusting delivery of the delivery item to the delivery agency and a recipient's terminal apparatus of the recipient receiving the delivery item, and the cryptogram reader comprises:
a means for obtaining a secret key from a server apparatus in order to decrypt recipient's encryption information encrypted and generated from at least recipient information needed for delivery of delivery items by means of an encryption program using a public key of the delivery agency;
a means for reading the recipient's encryption information and decrypting it using the secret key; and
a means for outputting the decrypted recipient's encryption information as human-readable recipient information.

10. The cryptogram reader according to claim 9,
wherein the cryptogram reader can decrypt sender's encryption information as sender's private information encrypted by the encryption program using the public key; and
wherein the cryptogram reader can output the encrypted sender's encryption information as human-readable sender information.

11. An item delivery method in which a public switched telephone network is used to make connection between a sender's terminal apparatus of a sender entrusting delivery of a delivery item to a delivery agency and a recipient's terminal apparatus of a recipient receiving the delivery item, the method comprising:
a step wherein the recipient's terminal apparatus obtains a public key of the delivery agency via a specified medium, uses the public key to encrypt recipient information containing at least recipient's private information needed for delivery of items and to generate recipient's encryption information, and transmits the recipient's encryption information to the sender's terminal apparatus;
a step wherein the sender's terminal apparatus outputs the transmitted recipient's encryption information in order to be attached to a delivery item entrusted to the delivery agency; and
a step wherein the delivery agency's cryptogram reader decrypts the output recipient's encryption information using the delivery agency's secret key so that the delivery agency obtains the recipient information.

12. The item delivery method according to claim 11, further comprising a step wherein the recipient's terminal apparatus attaches information about the delivery agency's public key to the recipient's encryption information and transmits it to the sender's terminal apparatus.

13. The item delivery method according to claim 11, further comprising:
a step wherein the sender's terminal apparatus obtains a public key of the delivery agency from the delivery agency server apparatus or via a specified medium, uses the public key to encrypt sender information about a sender to generate sender's encryption information, and outputs the sender's encryption information to be attached to a delivery item entrusted to the delivery agency; and
a step wherein the delivery agency's cryptogram reader decrypts the output sender's encryption information using the delivery agency's secret key so that the delivery agency obtains the sender information.

14. The item delivery method according to claim 11, wherein the recipient's encryption information comprises at least coded information.

15. The item delivery method according to claim 11, wherein an output of the recipient's encryption information contains at least a name identifying the recipient.

16. A program for a computer of a delivery agency which delivers a delivery item entrusted by a sender to a recipient, wherein a public switched telephone network is used to make connection between a sender's terminal apparatus of the sender entrusting delivery of the delivery item to the delivery agency and a recipient's terminal apparatus of the recipient receiving the delivery item, and the program allows the computer to function as:
a public key management means for managing a public key to execute an encryption program which encrypts recipient information containing at least recipient's private information needed for delivery of delivery items;
a public key transmission means for transmitting the public key to the recipient's terminal apparatus in response to a request from the recipient's terminal apparatus;
a secret key management means for managing a secret key to decrypt recipient's encryption information encrypted and generated by the encryption program using the public key from recipient information containing at least recipient's private information needed for delivery of delivery items; and
a secret key provision means for providing the secret key to a cryptogram reader which decrypts the recipient's encryption information.

17. A computer-readable storage medium recording a program for a computer of a delivery agency which delivers a delivery item entrusted by a sender to a recipient, wherein a public switched telephone network is used to make connection between a sender's terminal apparatus of the sender entrusting delivery of the delivery item to the delivery agency and a recipient's terminal apparatus of the recipient receiving the delivery item, and the program allows the computer to function as:
a public key management means for managing a public key to execute an encryption program which encrypts recipient information containing at least recipient's private information needed for delivery of delivery items;
a public key transmission means for transmitting the public key to the recipient's terminal apparatus in response to a request from the recipient's terminal apparatus;
a secret key management means for managing a secret key to decrypt recipient's encryption information encrypted and generated by the encryption program using the public key from recipient information containing at least recipient's private information needed for delivery of delivery items; and
a secret key provision means for providing the secret key to a cryptogram reader which decrypts the recipient's encryption information.
